(19) United States
(12) Patent Application Publication
(10) Pub. No.: US 2021/0404675 A1
(43) Pub. Date: Dec. 30, 2021

(54) WET SURFACE AIR COOLER WITH COUNTER CURRENT DIRECT HEAT EXCHANGE SECTION

(71) Applicant: ALFA LAVAL CORPORATE AB, Lund (SE)

(72) Inventors: Christian Pawlak, Depew, NY (US); Kevin Shahrpass, Ransomville, NY (US)

(73) Assignee: ALFA LAVAL CORPORATE AB, Lund (SE)

(21) Appl. No.: 16/915,294

(22) Filed: Jun. 29, 2020

(51) Int. Cl. F24F 5/00

(52) U.S. Cl. CPC F24F 5/0035

(57) ABSTRACT

A wet surface air cooler (WSAC), including a tube bundle having a process medium therein, a first inlet, a nozzle assembly positioned adjacent to the first inlet for spraying water over the tube bundle to cool the process medium, an outlet, a fill section spaced from the tube bundle and positioned directly below the outlet, a second inlet provided in an outer wall of the WSAC and positioned below the fill section, the second inlet being configured to provide air from outside the WSAC to the fill section, a fan assembly for causing cause air to flow through the inlet, then past the tube bundle, to be mixed with air flowing through the second inlet, and out the outlet, and a basin extending an entire width of the WSAC for receiving water sprayed from the nozzle assembly.

### BACKGROUND OF THE INVENTION

### 1. Field of Invention

The present invention is directed to a wet surface air cooler (WSAC) having improved energy efficiency and improved thermal performance.

### 2. Description of the Background Art

Existing evaporative cooling technologies, such as existing wet surface air coolers for industrial applications, have a large footprint and high operating cost.

A traditional WSAC (e.g., evaporative cooler) is comprised of a tube bundle for facilitating process fluid flow, a spray system that distributes water over a top of the tube bundle, and a fan or a set of fans that pulls air through the tube bundle. The air/spray water mixture on the outside surfaces of the tubes provides an evaporative cooling effect that removes heat from the process fluid and then rejects the heat out of both the fan stack and back into the spray water collection basin.

For instance, U.S. Pat. No. 6,598,862 (herein “862 patent”), which is incorporated by reference in its entirety, discloses an evaporative cooler including a direct heat transfer section 324 separated from an indirect cooling section or indirect heat transfer section 330 by a wall 369, the wall 369 extending to a liquid collector 338 (e.g., a basin), and the liquid collector 338 collecting water ejected from nozzles 344 of the direct heat transfer section 324 and water ejected from nozzles 382 of the indirect cooling section 330. Pumps 362 and 376 are provided for recirculating water from the liquid collector 338 to respective nozzles 382, 344 (862 patent FIG. 7 and column 13, lines 31-39). Further, the 862 patent discloses that the direct heat transfer section 324 includes a wet deck fill 326, a drift eliminator 352 and “the air flows in through air inlets 348 and up through the fill 326 to pass through the drift eliminator 352 and past the air moving device 328 to exit through the opening 350” (862 patent FIG. 7, column 12, lines 59-62 and column 14, lines 1-6). The 862 patent discloses that it is desired to have the coil 332 outside of the air flow, which is achieved by the wall 369, such that “the heat transfer coil 332 is positioned substantially outside of the flow of air through the housing” to reduce the need for additional flow requirements and reduce the need for “extra air moving horsepower” (862 patent column 2, lines 29-32 and column 14, lines 1-3).

### SUMMARY OF THE INVENTION

The present invention is directed to an improved wet surface air cooler that utilizes a combination of tube bundles, a cooling tower fill, a fan assembly and multiple inlets for cooling air that passes through the tube bundles.

The invention being disclosed in this form enhances this process by adding a direct heat exchange section comprised of cooling tower fill under the fan section of the unit. As the warmed water falls from the tube bundle, it collects in a basin and a pump/piping system distributes the warmed water into the direct heat exchange section. As this water falls through the direct heat exchange section, the shared fan system pulls air vertically through the fill creating a countercurrent effect. The water then is cooled as it falls through the fill section into a collection basin. This cooled water is then pumped back over the coil thereby making the evaporative cooling process more efficient due to the reduced temperature of the spray water.

In contrast to the 862 patent and the conventional art, the present invention provides a combined flow of exhaust air from a tube bundle and fresh air (e.g., air from outside of the WSAC) that passes through a fill section to improve energy efficiency of the WSAC (e.g., improve the WSAC's ability to remove heat from the tube bundle, thereby improving thermal efficiency of the WSAC).

According to the invention, a smaller, cheaper, and more efficient unit is anticipated that makes better use of the surface area used over current offerings.

According to a first embodiment of the present invention, a wet surface air cooler (WSAC) comprises a tube bundle configured to have a process medium flowing therethrough, a first inlet disposed on a first top surface of the WSAC for introducing air through the tube bundle, a first nozzle assembly positioned adjacent to the first inlet, the first nozzle assembly being configured to spray water over the tube bundle to cool the process medium, an outlet disposed on a second top surface of the WSAC spaced from the first top surface of the WSAC in a horizontal direction, a fill section spaced from the tube bundle in the horizontal direction and positioned below the outlet, a second inlet provided in an outer wall of the WSAC and positioned below the fill section, the second inlet being configured to provide air from outside the WSAC to the fill section, and a fan assembly configured to cause air to flow through the first inlet, then through tube bundle and cause air to flow through the second inlet, to be mixed with the air exhausted through the tube bundle, into the fill section and out of the outlet.

According to an aspect of the first embodiment, the second top surface of the WSAC is positioned above the first top surface of the WSAC.

According to an aspect of the first embodiment, a bottom surface of the tube bundle is positioned below the fill section.

According to an aspect of the first embodiment, the WSAC further comprises a basin configured to receive water sprayed from the first nozzle assembly, and a drift eliminator positioned above the fill section and below the fan assembly, the drift eliminator is configured to capture water droplets to allow the water droplets to fall down to the basin.

According to an aspect of the first embodiment, the WSAC further comprises a basin configured to receive water sprayed from the first nozzle assembly, and a second nozzle assembly positioned below the fan assembly and above the fill section, the second nozzle assembly is configured to spray water over the fill section, and the fill section is configured to cool water sprayed from the second nozzle assembly.

According to an aspect of the first embodiment, the basin is further configured to receive water from the second nozzle assembly, and the second nozzle assembly extends an entire width of the fill section.

According to an aspect of the first embodiment, the WSAC further comprises a pump provided in the basin, the pump is fluidly connected to the first nozzle assembly and is fluidly connected to the second nozzle assembly, and the pump is configured to pump water from the basin to the first nozzle assembly and to the second nozzle assembly.

According to an aspect of the first embodiment, the second inlet comprises a first plate, and a second plate, and wherein the WSAC further comprises an actuator mechanically attached to the second plate and configured to move the second plate to overlap the first plate to adjust flow of air through the second inlet.

According to an aspect of the first embodiment, the WSAC further comprises a basin configured to receive water sprayed from the first nozzle assembly, and a pump provided in the basin, the pump is fluidly connected to the first nozzle assembly and is configured to pump water from the basin to the first nozzle assembly.

According to an aspect of the first embodiment, the WSAC further comprises at least one plate for adjusting the flow of air through the second inlet.

According to an aspect of the first embodiment, the at least one plate includes two plates, and at least one aperture is formed in at least one of the two plates for adjusting the flow of air through the second inlet.

According to an aspect of the first embodiment, the fan assembly is configured to cause air that passes through the tube bundle to be mixed with air passing through the second inlet to increase the cooling capacity of air flowing through the fill section.

According to a second embodiment of the present invention, a wet surface air cooler (WSAC) comprises a tube bundle configured to have a process medium flowing therethrough, an inlet disposed on a first top surface of the WSAC, an outlet disposed on a second top surface of the WSAC spaced from the first top surface of the WSAC in a horizontal direction, a fill section positioned below the outlet, a first nozzle assembly positioned adjacent to the first inlet, the first nozzle assembly being configured to spray water over the tube bundle to cool the process medium, a second nozzle assembly positioned below the outlet and configured to spray water over the fill section, a perforated plate or a series of perforated plates provided in an outer wall of the WSAC and positioned below the fill section, a fan assembly configured to cause air to flow through the inlet and air to flow through the perforated plate to be mixed together and to flow through the fill section, and a basin configured to receive water sprayed from the first nozzle assembly and the second nozzle assembly.

According to an aspect of the second embodiment, the second top surface of the WSAC is positioned above the first top surface of the WSAC.

According to an aspect of the second embodiment, a bottom surface of the tube bundle is positioned below the fill section.

According to an aspect of the second embodiment, the fill section extends an entire width of the fan assembly, and a bottom surface of the tube bundle is positioned below the fill section.

According to an aspect of the second embodiment, the WSAC further comprises a drift eliminator positioned above the fill section and below the fan assembly, and the drift eliminator is configured to capture water droplets to allow the water droplets to fall down to the basin.

According to an aspect of the second embodiment, the WSAC further comprises a pump provided in the basin, the pump is fluidly connected to the first nozzle assembly and is fluidly connected to the second nozzle assembly, and the pump is configured to pump water from the basin to the first nozzle assembly and to the second nozzle assembly.

According to an aspect of the second embodiment, the perforated plate comprises a predetermined number of perforations to optimize the blending of the air to improve thermal efficiency of the WSAC.

According to a third embodiment of the present invention, a method of operating a wet surface air cooler (WSAC), the WSAC including a tube bundle, a first inlet disposed on a first top surface of the WSAC, an outlet disposed on a second top surface of the WSAC spaced from the first top surface of the WSAC in a horizontal direction, a fill section positioned below the outlet, a first nozzle assembly positioned adjacent to the first inlet, a second nozzle assembly positioned below the outlet, a second inlet provided in an outer wall of the WSAC and positioned below the fill section, and a fan assembly, the method comprises flowing process medium through the tube bundles, controlling the first nozzle assembly to spray water over the tube bundle to cool the process medium, controlling the second nozzle assembly to spray water over the fill section; and operating the fan assembly to cause air to flow through the first inlet and air to flow through the second inlet to be mixed together and to flow through the fill section.

According to an aspect of the third embodiment, the second inlet comprises a first perforated plate, and the method further comprises replacing the first perforated plate with a second perforated plate, the second perforated plate having different air flow characteristics from the first perforated plate.

According to an aspect of the third embodiment, the method further comprises adjusting the speed of fan assembly to alter the air flow through the WSAC.

Further scope of applicability of the invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a cross-sectional view of the WSAC according to the present invention;

FIGS. 2A and 2B are cross-sectional views of an embodiment of the variable area perforated plate;

FIG. 3 is a cross-sectional view of an embodiment of the variable area perforated plate;

FIG. 4 is a cross-sectional view of an embodiment of the variable area perforated plate; and

FIG. 5 is a cross-sectional view of the second inlet in the form of a plurality of louvers.

### DETAILED DESCRIPTION OF THE PREFERRED EMBODIMENTS

The present invention will now be described with reference to the accompanying drawings, wherein the same reference numerals have been used to identify the same or similar elements throughout the several views.

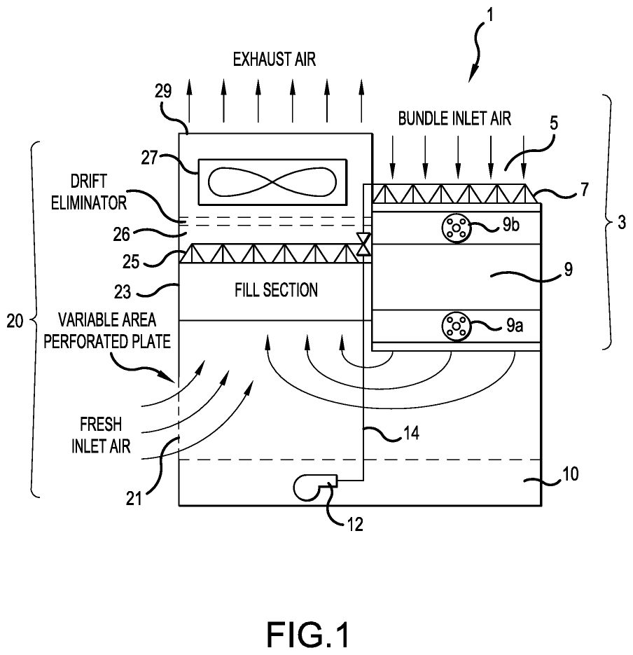

FIG. 1 is a cross-sectional view of a WSAC according to the present invention. The WSAC 1 includes an indirect cooling section 3 having a first inlet 5, a first nozzle assembly 7 and at least one tube bundle 9 (e.g., coil). The first inlet 5 may be disposed on a first top surface of the WSAC 1 and may be in the form of an opening or a plurality of openings for allowing air to pass through the first nozzle assembly 7 and the tube bundle 9.

The tube bundle may include an inlet 9a and an outlet 9b. The outlet 9b of the tube bundle may be positioned above the inlet 9a.

Hot process medium flows through the tube bundle 9, as known in the art. The hot process medium is cooled by the co-current flow of air, via the first inlet 5, and spray water, sprayed from the first nozzle assembly 7, on the outside of the tubes of the tube bundle 9, which causes evaporation of the water, which is mixed with the air incoming from the first inlet 5. This evaporative cooling process is very efficient as compared to convective heat transfer taking place in a traditional dry air cooler.

The hot process medium may be any type of medium known in the art, such as water, glycol, oil, fuel, gasses or the like, or for condensing steam, ammonia, propylene, butane, or the like.

The WSAC further includes a basin 10 (e.g., water chamber or sump), a pump 12 or a plurality of pumps 12 provided in the basin 10 and one or more pipes 14 connected from the pump 12 to the first nozzle assembly 7 of the indirect cooling section 3. That is, the pump 14 may be fluidly connected to the first nozzle assembly 7 by the one or more pipes 14. The pump 12 may be any type of pump known in the art for pumping fluid. The pump 12 pumps water collected by the basin 10 to the first nozzle assembly 7 via the one or more pipes 14, and the first nozzle assembly 7 sprays the tube bundle 9 with the water pumped from the basin, which then falls back down to the basin 10, and continues the process of being pumped back up to the first nozzle assembly 5. The one or more pipes 14 are illustrated as being provided inside the WSAC 1, but may be provided on the outside of the WSAC 1 (e.g., an outside surface of the WSAC 1), depending on the application, for distributing the collected water from the basin 10 to the first nozzle assembly 7.

Thus, the WSAC 1 of the present invention is a closed-loop cooling system because the hot process medium is inside the tube bundle 9 of the WSAC and the recirculating spray water is sprayed, via the first nozzle assembly 7, on the outside of the tube bundle 9 creating an evaporative cooling effect, and this recirculating spray water never contacts the process water/fluid included in the tubes. Further, the air flow around the tube is on the outside of tube bundles. The air flow may be the main cooling medium and the spray water may provide an additional evaporative effect.

The tubes of the tube bundle 9 may have a circular or oval cross-section and may be finned to improve heat dissipation. That is, the entirety of the tubes of the tube bundle 9 may have fins extending radially outward from the tubes, or in the alternative, less than an entirety of the tubes of the tube bundle 9 may be provided with fins. The tubes of the tube bundle 9 may be made of any known material in the art, such as stainless steel, galvanized steel, etc.

Further, the water sprayed over the tube bundle may comprise flex water, which may be of much lower quality than water used in a cooling tower, such as used in the conventional art. The tubes of the tube bundle 9 may be equally spaced apart from one another by a predetermined distance, in order to prevent possible debris from the water that is sprayed by the first nozzle assembly 7 from being caught in the tube bundle 9.

The pump 12 may include a pump screen for screening (e.g., filtering) debris and other contaminants from the falling water in order to allow the reuse of the spray water for multiple iterations, such as for a duration of at least ten cycles. Therefore, the WSAC 1 reduces the need for fresh water use, and can utilize waste water from a cooling tower, a wastewater treatment plant, or any other known water source.

The WSAC 1 further includes a direct heat exchange section 20. The direct heat exchange section 20 includes a second inlet 21, a fill section 23, and a second nozzle assembly 25. The direct heat exchange section 20 may additionally include a drift eliminator 26 above the fill section 25 for capturing water droplets, the captured water droplets then falling back into the basin 10. That is, the drift eliminator 26 facilitates removing entrained liquid droplets in the air stream (i.e., the mixed air stream including air from the first inlet 5 and the second inlet 21) prior to the air stream exiting the WSAC 1 via the outlet 29.

A bottom surface of the tube bundle 9 may be positioned below the fill section 23, and a top surface of the tube bundle 9 may be positioned above the fill section 23.

Further, the WSAC 1 may additionally include a fan assembly 27 (e.g., an exhaust fan) and an outlet 29 above the direct heat exchange section 20. The fan assembly 27 may include a fan and a frame (e.g., surround), and the frame of the fan may be attached to the WSAC 1 in any known manner.

The fan assembly 27 may encompass an entire width of the direct heat exchange section 20, such as air only passes through the fan assembly 27 and does not pass around the fan assembly 27. The drift eliminator 26 may be provided between the fan assembly 27 and the fill section 25.

The present invention enhances the evaporative cooling process by adding the direct heat exchange section 20 comprised of the second nozzle assembly 25, the fill section 23 below the second nozzle assembly 25 and below the fan assembly 27, and the outlet 29, and optionally the drift eliminator 26, which may be located between the fan assembly 27 and the second nozzle assembly 25. The pump 12 may additionally be fluidly connected, by the one or more pipes 14, to the second nozzle assembly 25. Alternatively, the WSAC may include a first pump 12 fluidly connected to the first nozzle assembly to pump water from the basin to the first nozzle assembly and a second pump 12 fluidly connected to the second nozzle assembly to pump water from the basin to the second nozzle assembly.

Water sprayed from the first nozzle assembly of the indirect cooling section 3 contacts the tube bundle 9 and is warmed (e.g., heated) by the tube bundle 9. As the warmed water falls from the tube bundle 9, it collects in the basin 10 and the pump 12 distributes the warmed water into the direct heat exchange section 20 via the second nozzle assembly 25. The second nozzle assembly 25 is provided directly above the fill section 23 and below the fan assembly 27. Further, if the WSAC 1 includes the drift eliminator 26, the second nozzle assembly 25 is provided directly between the drift eliminator 26 and the fill section 25.

Further, the hot process medium is cooled by the flow of air around the tubes of the tube bundle 9. The flow of air around the tubes of the tube bundle 9 is caused by the fan assembly 27 pulling air from the first inlet 5 (e.g., the fan assembly 27 causing a negative pressure within the WSAC 1).

Heat from the hot process medium within the tube bundle 9 causes some of the water over the tube bundle 9 to evaporate and causes the air to warm as it passes around the tube bundle 9 and to create an air and water vapor stream.

The vapor stream is forced to make a 180° turn, due to contacting the basin 10 (e.g., contacting the basin 10 directly or the water within the basin 10), towards the direct heat exchange section 20, which aids in removing some free water droplets by gravity separation, and the warmed air is mixed with cooler outdoor air (air outside of the WSAC 1) pulled in from the second inlet 21 (i.e., via the fan assembly 27), before it reaches the fill section 23, thereby improving the ability of the fill section 23 to cool the water falling from the second nozzle assembly 25, thus improving the thermal efficiency of the WSAC 1. That is, the mixed air flows counter-current through the fill section 23 relative to the water sprayed from the second nozzle assembly 25, as opposed to a cross flow arrangement where fresh air enters through the side of the unit and then flows across the fill section. The water falling from the second nozzle assembly 25 falls to the basin 10, which is pumped, by the pump 12, to the first nozzle assembly 7 and the second nozzle assembly 25, and thus improves the efficiency (thermal efficiency) of the WSAC 1.

A bottom surface of the indirect cooling section 3 (e.g., a bottom surface of the tube bundle 9) may be disposed below a bottom surface of the fill section 23. Further, the WSAC 1 is provided without a barrier between the indirect cooling section 3 and the direct heat exchange section 20 such that air can flow directly from the indirect cooling section 3 (e.g., exhaust air from the tube bundle 9) to the direct heat exchange section 20 to be mixed with the air flowing through the second inlet 21 to reduce the temperature of the air and improve the thermal efficiency of the WSAC 1.

The fan assembly 27 of the direct heat exchange section 20 pulls air through the first inlet 5 and the second inlet 21, which is mixed together and pulled through the fill section 23 to create a countercurrent effect. Combining outdoor air (e.g., fresh air) via the second inlet 21 with air from the tube bundle 9 increases the cooling capacity of the air flowing through the fill section 23, thereby cooling the water sprayed from the second nozzle assembly 25 onto the fill section 23. This cooled water (e.g., water sprayed from the second nozzle assembly 25 and passing through the fill section 23), falls to the basin 10 and is pumped to the first nozzle assembly 7 and the second nozzle assembly 25. That is, the direct heat exchange section 20 reduces the temperature of the water in the basin 10, thereby improving the evaporative efficiency of the water sprayed onto the tube bundle 9 by the first nozzle assembly 7. By mixing the air flow of air from the first inlet 5 and air flow of air from the second inlet 21, and providing a second nozzle assembly 25 and a fill section 23, the efficiency of the WSAC 1 can be increased. Further, the air from the first inlet 5 and from the second inlet 21 can be blended to the optimal temperature for the most efficient operation of the WSAC 1, including by varying the size and/or shape of one or both of the first inlet 5 and the second inlet 21.

The fill section 23 may include a plurality of wooden slats, at least one metal sheet, such as at least one corrugated metal sheet, or a plurality of metals sheets, the plurality of metal sheets may be corrugated and stacked on one another, at least one plastic sheet, such as at least one corrugated plastic sheet, or a plurality of plastic sheets, the plurality of plastic sheets may be corrugated and stacked on one another, or any other material and construction known in the art, such as described in U.S. Pat. No. 5,124,087, which is incorporated by reference in its entirety. The fill section may alternatively be comprised of packing, which can be made out of anything, including wood, metal, aluminum, copper, plastic (e.g., thermoplastic), a plastic alloy (e.g., a thermoplastic alloy) or ceramic and is densely packed. Further, the packing may have a honeycomb shape or any other shape.

The drift eliminator 26 may be a PVC sheeting or may be comprised of any other material, that captures water droplets so they fall back down to the basin. The drift eliminator 26 may be provided directly above the second nozzle assembly 25, above the fill section 23, and below the fan assembly 27. The drift eliminator 26 may comprise closely spaced metal, plastic or wooden slats or louvers, to permit air flow through while collecting fine water droplets from the air. The collected water, through gravitational force, falls down to the basin for recirculation, via the pump 12, to the first nozzle assembly 7 and the second nozzle assembly 25.

Further, the WSAC 1 of the present invention allows for improved temperature control due to the closed-loop design. Additional temperature control may be performed by a resistance temperature detector (RTD) or the like, for monitoring of outlet fluid temperature (e.g., temperature of air passing through the outlet 29), combined with logic control of the fan assembly 27 to effectively modulate heat rejection capacity of the WSAC 1. The logic control of the fan assembly 27 may be performed by a controller and may comprise a processor (e.g., CPU, controller, etc.), and the like, as known in the art.

The fan assembly 27 may be comprised of a composite material, such as a composite of plastic and metal, stainless steel, galvanized carbon steel or any other material known in the art.

The outlet 29 may be provided at a second top surface of the WSAC 1 and may be spaced apart from the first inlet 5 in a horizontal direction and in a vertical direction. Further, the outlet 29 may be positioned at a greater height in the vertical direction than the first inlet 5, such that the outlet 29 is positioned above the first inlet 5 while being horizontally spaced therefrom.

The basin 10 may extend an entire width of the indirect cooling section 3 and the direct heat exchange section 20, for collecting water falling from the indirect cooling section 3 and water falling from the direct heat exchange section 20. The basin 10 may be comprised of concrete, a polymeric material, galvanized carbon steel, stainless steel or any other known material, and the first nozzle assembly 5 and the second nozzle assembly 27 may be comprised of galvanized carbon steel, polyvinyl chloride (PVC), stainless steel or any other material known in the art.

Alternatively, the basin 10 may be separately provided from the WSAC 1. For instance, the basin 10 may be first constructed, then the WSAC 1 may be positioned on the basin 10 and then the WSAC 1 may be attached (or may not be attached) to the basin 10. The WSAC 1 may have the same or similar dimensions as the basin 10, such that water sprayed from the first nozzle assembly 7 and the second nozzle assembly 25 is collected in the basin 10, and pumped, via the pump 12 and the one or more pipes 14 to the first nozzle assembly 7 and the second nozzle assembly 25.

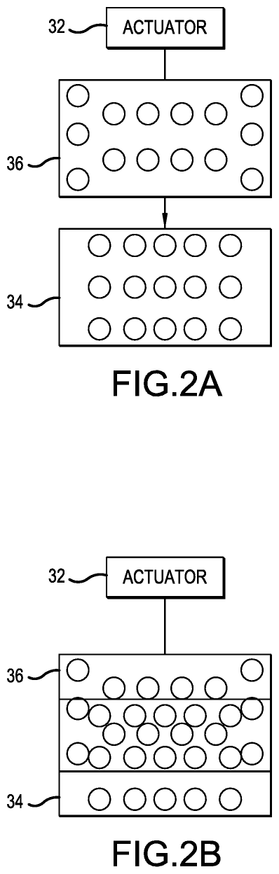

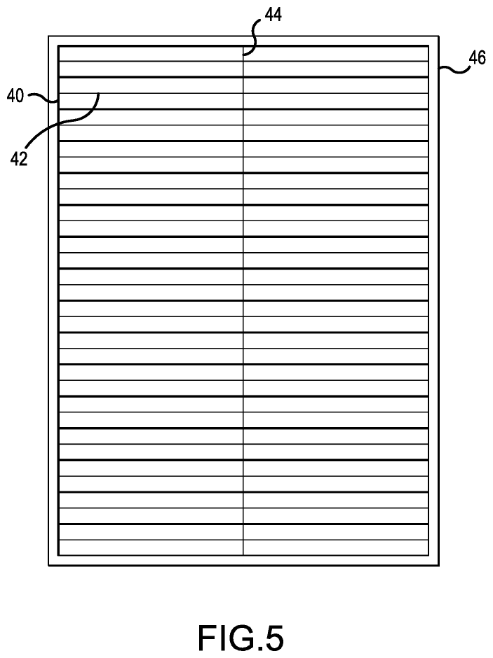

The second inlet 21 may include one perforated plate, as shown in FIGS. 2A, 2B, 3, and 4, with at least one aperture, a plurality of plates with at least one aperture, or louvers, as shown in FIG. 5. The number of the at least one aperture may be predetermined based on desired air flow characteristics.

The air flow characteristics may depend on the particular application, such as the temperature of the hot process medium tube bundle 9, the outside temperature, the size and output of the fan assembly 27, the size of the WSAC 1, etc.

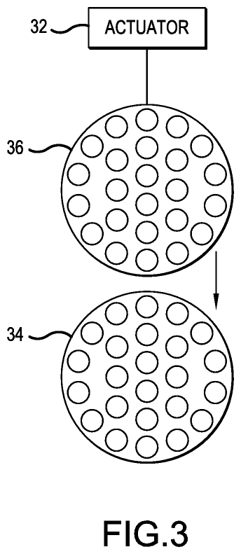

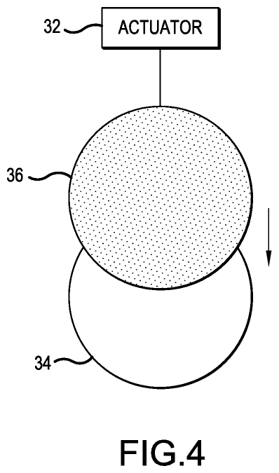

Further, the second inlet 21 of the direct heat exchange section 20, which may be in the form of a first plate 34 shown in FIGS. 2A, 2B, 3 and 4, or a bezel 46 and louvers 40 shown in FIG. 5. Alternatively, the second inlet 21 may correspond to (e.g., can be the exact dimensions of) the size of the first plate 34 shown in FIGS. 2A, 2B, 3 and 4, or the size of the bezel 46 shown in FIG. 5. Further, the second inlet 21 may have a circular shape, such as shown in FIGS. 3 and 4, or a rectangular shape, such as shown in FIGS. 2A and 2B. The second inlet 21 may be positioned on a side wall of WSAC 1 below the fill section 23, and may be any size and shape predetermined to optimize air flow through the fill section 23 and to improve the heat exchange efficiency of the fill section 23.

In the embodiment of the present invention having one perforated plate to control the air flow, the air flow can be made variable by exchanging the one perforated plate for another perforated plate having more or less apertures, thus controlling the air flow through the second inlet 21. That is, the WSAC 1 may initially include a first perforated plate having first air flow characteristics through the second inlet 21, and if different air flow characteristics through the second inlet 21 are desired, such as to optimize air flow through the WSAC and/or improve cooling and/or thermal efficiency, the first perforated plate may be replaced with a second perforated plate having different air flow characteristics from the first perforated plate. For instance, the second perforated plate may have more or less perforations, or have differently sized perforations from the first perforated plate. Further, the first perforated plate may be replaced with any number of perforated plates, each of the perforated plates having different structure and/or shape and different air flow characteristics.

Alternatively, in the embodiment of the present invention having a plurality of plates, as shown in FIGS. 2A, 2B, 3 and 4, two plates 34, 36 are brought together to adjust the air flow characteristics of the second inlet 21 to the fill section 23. That is, one or both the plates may be moveable, including by an actuator 32, such as a hydraulic or electric actuator as known in the art. The actuator 32 may be directly (e.g., mechanically) connected to a second plate 36 among the two plates 34, 36. Further, the actuator 32 may be controlled by a controller (e.g., CPU or processor), and may be automatically adjusted based on a number of conditions, such as outside temperature, outside wind speed, temperature of the hot process medium, etc. In any event, the two plates 34, 36 are slidable against each other in order to adjust the amount of air flowing through the second inlet 21.

Each of the two plates 34, 36 may be perforated with any number of perforations, and the perforations in the two plates 34, 36 may be positioned such that they overlap or such that they do not overlap, depending on the desired air flow characteristics desired.

FIGS. 2A and 2B show the plates 34 and 36 being rectangular and FIG. 3 shows the plates 34 and 36 being circular. However, the plates 34 and 36 may have any shape.

FIG. 4 illustrates a first plate 34 of the two plates 34, 36 having a single large aperture and a thin bezel portion, and the second plate 36 of the two plates being completely solid. The second plate 36 may be mechanically attached to an actuator 32, and thus movable, by the actuator 32, to overlap the first plate 34. The first plate 34 may be fixed while the second plate 36 may be movable by the actuator 32. The overlapping of the first plate 34 by the second plate 36 alters the flow characteristics of air passing through the second inlet 21. Of course, a single movable plate 36 could be used, overlapping with the second inlet 21, in order to adjust the air flow through the second inlet 21, rather than providing the second plate 36 with a large aperture. In such case, the single movable plate 36 would slide against a surface of the housing of the WSAC 1 in which the second inlet 21 is formed. The single movable plate 36 could be manually movable or could be automatically movable with an actuator 32.

FIG. 5 illustrates the second inlet 21 in the form of a plurality of plates or louvers 40 and a bezel 46 (e.g., outer frame). Each of the louvers 40 have the same size and shape, and each louver 40 may include a shaft 42 extending therethrough to attach the louvers to the bezel 46. Each shaft 42 permits rotation of the respective louver 40 to adjust the air flow through the respective louver 40. Further, each shaft 42 of each louver 40 may be connected by a single connecting member 44, which may be in the form of a rod. Movement of the connecting member 44 causes rotation of each shaft 42, thereby rotating each louver 40, for adjusting air flow through the second inlet 21. The louvers 40 may be manually adjustable, and may be adjusted depending on the designed air flow characteristics through the second inlet 21. Alternatively, the louvers 40 may be automatically adjustable, for instance by a controller (computer, CPU, processor), and may be adjusted depending on the desired air flow characteristics through the second inlet 21

The present invention improves thermal efficiency of the WSAC 1 by providing a fan assembly 27, an indirect cooling section 3 in communication (i.e., thermal communication) with a direct heat exchange section 20 including a second nozzle assembly 26, a fill section 23 and a second inlet 21. Water is sprayed over to the tube bundle 9 of the indirect cooling section 3 by the first nozzle assembly 7, which flows in a co-current direction and mixed with air from the first inlet 5 drawn in by the fan assembly 27. The combination of water sprayed from the first nozzle assembly 7 and the air drawn in from the first inlet 5 causes a continuous film of water over the tubes of the tube bundle 9. Heat from the hot process medium (e.g., process fluid) within the tube bundle 9 causes some of the water over the tube bundle 9 to evaporate and causes the air to warm as it passes around the tube bundle 9 and to create an air and water vapor stream.

The air and water vapor stream is forced to make a 180° turn, due to the basin 10 (e.g., contacting the basin 10 or contacting water in the basin 10), to the direct heat exchange section 20, and is mixed with cooled outdoor air (air outside of the WSAC 1) from the second inlet 21, before it reaches the fill section 23, thereby improving the ability of the fill section 23 to cool the water falling from the second nozzle assembly 25, thus providing colder water to the first nozzle assembly 7, for improving the heat exchange efficiency of the water sprayed by the first nozzle assembly 7 onto the tube bundle 9. The cycle of pumping water from the basin 10 to the first nozzle assembly 7 and the second nozzle assembly 25, for spraying over the tube bundle 9 and the fill section 23, respectively, continues indefinitely.

The disclosure of which described above is not limited to the materials and features described therein, and may be changed within the scope of one ordinary skill in the art.

What is claimed is:

1. A wet surface air cooler (WSAC), comprising:
a tube bundle configured to have a process medium flowing therethrough;
a first inlet disposed on a first top surface of the WSAC for introducing air through the tube bundle;
a first nozzle assembly positioned adjacent to the first inlet, the first nozzle assembly being configured to spray water over the tube bundle to cool the process medium;
an outlet disposed on a second top surface of the WSAC spaced from the first top surface of the WSAC in a horizontal direction;
a fill section spaced from the tube bundle in the horizontal direction and positioned below the outlet;
a second inlet provided in an outer wall of the WSAC and positioned below the fill section, the second inlet being configured to provide air from outside the WSAC to the fill section; and
a fan assembly configured to:
cause air to flow through the first inlet, then through tube bundle, and
cause air to flow through the second inlet, to be mixed with the air passing through the tube bundle, into the fill section and out of the outlet.

2. The WSAC of claim 1, wherein the second top surface of the WSAC is positioned above the first top surface of the WSAC.

3. The WSAC of claim 1, wherein a bottom surface of the tube bundle is positioned below the fill section.

4. The WSAC of claim 1, further comprising:
a basin configured to receive water sprayed from the first nozzle assembly; and
a drift eliminator positioned above the fill section and below the fan assembly,
wherein the drift eliminator is configured to capture water droplets to allow the water droplets to fall down to the basin.

5. The WSAC of claim 1, further comprising:
a basin configured to receive water sprayed from the first nozzle assembly; and
a second nozzle assembly positioned below the fan assembly and above the fill section,
wherein the second nozzle assembly is configured to spray water over the fill section, and
wherein the fill section is configured to cool water sprayed from the second nozzle assembly.

6. The WSAC of claim 5, wherein the basin is further configured to receive water from the second nozzle assembly, and
wherein the second nozzle assembly extends an entire width of the fill section.

7. The WSAC of claim 5, further comprising a pump provided in the basin,
wherein the pump is fluidly connected to the first nozzle assembly and is fluidly connected to the second nozzle assembly, and
wherein the pump is configured to pump water from the basin to the first nozzle assembly and to the second nozzle assembly.

8. The WSAC of claim 1, wherein the second inlet comprises:
a first plate; and
a second plate, and
wherein the WSAC further comprises an actuator mechanically attached to the second plate and configured to move the second plate to overlap the first plate to adjust the flow of air through the second inlet.

9. The WSAC of claim 1, further comprising
a basin configured to receive water sprayed from the first nozzle assembly; and
a pump provided in the basin,
wherein the pump is fluidly connected to the first nozzle assembly and is configured to pump water from the basin to the first nozzle assembly.

10. The WSAC of claim 1, further comprising at least one plate for adjusting the flow of air through the second inlet.

11. The WSAC of claim 10, wherein the at least one plate includes two plates, and
wherein at least one aperture is formed in at least one of the two plates for adjusting the flow of air through the second inlet.

12. The WSAC of claim 10, wherein the fan assembly is configured to cause air that passes through the tube bundle to be mixed with air passing through the second inlet to increase the cooling capacity of air flowing through the fill section.

13. A wet surface air cooler (WSAC), comprising:
a tube bundle configured to have a process medium flowing therethrough;
an inlet disposed on a first top surface of the WSAC;
an outlet disposed on a second top surface of the WSAC spaced from the first top surface of the WSAC in a horizontal direction;
a fill section positioned below the outlet;
a first nozzle assembly positioned adjacent to the first inlet, the first nozzle assembly being configured to spray water over the tube bundle to cool the process medium;
a second nozzle assembly positioned below the outlet and configured to spray water over the fill section;
a perforated plate or a series of perforated plates provided in an outer wall of the WSAC and positioned below the fill section;
a fan assembly configured to cause air to flow through the inlet and air to flow through the perforated plate to be mixed together and to flow through the fill section; and
a basin configured to receive water sprayed from the first nozzle assembly and the second nozzle assembly.

14. The WSAC of claim 13, wherein the second top surface of the WSAC is positioned above the first top surface of the WSAC.

15. The WSAC of claim 13, wherein a bottom surface of the tube bundle is positioned below the fill section.

16. The WSAC of claim 13, wherein the fill section extends an entire width of the fan assembly, and
wherein a bottom surface of the tube bundle is positioned below the fill section.

17. The WSAC of claim 13, further comprising a drift eliminator positioned above the fill section and below the fan assembly,
wherein the drift eliminator is configured to capture water droplets to allow the water droplets to fall down to the basin.

18. The WSAC of claim 13, further comprising a pump provided in the basin,
wherein the pump is fluidly connected to the first nozzle assembly and is fluidly connected to the second nozzle assembly, and
wherein the pump is configured to pump water from the basin to the first nozzle assembly and to the second nozzle assembly.

19. The WSAC of claim 13, wherein the perforated plate or the series of perforated plates comprises a predetermined number of perforations to optimize the blending of the air to improve thermal efficiency of the WSAC.

20. A method of operating a wet surface air cooler (WSAC), the WSAC including:
a tube bundle;
a first inlet disposed on a first top surface of the WSAC;
an outlet disposed on a second top surface of the WSAC spaced from the first top surface of the WSAC in a horizontal direction;
a fill section positioned below the outlet;
a first nozzle assembly positioned adjacent to the first inlet;
a second nozzle assembly positioned below the outlet;
a second inlet provided in an outer wall of the WSAC and positioned below the fill section; and
a fan assembly,
the method comprising:
flowing process medium through the tube bundles;
controlling the first nozzle assembly to spray water over the tube bundle to cool the process medium;
controlling the second nozzle assembly to spray water over the fill section; and
operating the fan assembly to cause air to flow through the first inlet and air to flow through the second inlet to be mixed together and to flow through the fill section.

21. The method of claim 20, wherein the second inlet comprises a first perforated plate, and
wherein the method further comprises replacing the first perforated plate with a second perforated plate, the second perforated plate having different air flow characteristics from the first perforated plate.

22. The method of claim 20, further comprising:
adjusting the speed of the fan assembly to alter the air flow through the WSAC.
